(19) United States
(12) Patent Application Publication
(10) Pub. No.: US 2018/0047218 A1
(43) Pub. Date: Feb. 15, 2018

(54) METHOD OF ATTAINING SUBJECTIVE VEHICLE DYNAMICS

(71) Applicant: GM GLOBAL TECHNOLOGY OPERATIONS LLC, Detroit, MI (US)

(72) Inventors: Stephen M. Della Monica, Fernadale, MI (US); Sandra J. Walker, Swartz Creek, MI (US); Daniel T. Cohen, West Bloomfield, MI (US)

(21) Appl. No.: 15/235,238

(22) Filed: Aug. 12, 2016

(51) Int. Cl. G07C 5/00; G06K 9/62; G06K 9/00; G07C 5/08

(52) U.S. Cl. CPC G07C 5/008; G07C 5/085; G06K 9/6267; G06K 9/00624

(57) ABSTRACT

A method of attaining subjective vehicle dynamics information that includes the steps of: (a) receiving, at a controller, one or more data transmissions comprising a vehicle identity; (b) accessing, via the controller, one or more data bases comprising vehicle capabilities information; (c) reviewing, via the controller, the vehicle capabilities information in relation to the vehicle identity; (d) generating, via the controller, subjective vehicle dynamics information based upon the review of the vehicle dynamics information in relation to the vehicle identity; and (e) transmitting one or more data transmissions comprising at least a portion of the subjective vehicle dynamics information.

### INTRODUCTION

The present disclosure relates to vehicles and more particularly to methods of attaining information of a vehicle's subjective dynamics and the limitations thereof.

Current methodologies provide maximum trailer-weight information for standard vehicle models which may be too general to depict the specific dynamics of one's own vehicle. Furthermore, one may not fully comprehend that the generic information does not accurately depict the dynamics of their vehicle. Such a misunderstanding could in turn lead them to the mistaken belief that they are able to connect trailers of weights unknowingly beyond their vehicle's performance capabilities, creating potentially hazardous circumstances for the vehicle operator and/or surrounding environment. To avoid this type of confusion, it is therefore desirable for a methodology that calculates and provides one with subjective vehicle dynamics pertaining to their specific vehicle. It is moreover desirable for this methodology to use the subjective vehicle dynamics to determine whether one's specific vehicle is dynamically capable of transporting a certain trailer weight.

### SUMMARY

A method of attaining subjective vehicle dynamics information is herein presented. The method includes the steps of: (a) receiving, at a controller, one or more data transmissions comprising a vehicle identity; (b) accessing, via the controller, one or more data bases comprising vehicle capabilities information; (c) reviewing, via the controller, the vehicle capabilities information in relation to the vehicle identity; (d) generating, via the controller, subjective vehicle dynamics information based upon the review of the vehicle dynamics information in relation to the vehicle identity; and (e) transmitting one or more data transmissions comprising at least a portion of the subjective vehicle dynamics information.

The method may further include the step of transmitting, via a mobile computing device, the one or more data transmissions comprising the vehicle identity to the controller. The vehicle identity may be acquired by the mobile computing device via a digital image captured by a camera. The method may further include the step of receiving, at a mobile computing device, one or more data transmissions from the controller, the one or more data transmissions comprising the subjective vehicle dynamics information.

The controller may be located at a data center server. The vehicle identity may incorporate vehicle dynamics information provided via one or more vehicle system modules. The vehicle identity may also incorporate trailer dynamics information provided via one or more trailer system modules. The subjective vehicle dynamics information may include a capabilities determination. The vehicle capabilities information may include a table populated with information regarding at least one of a Gross Vehicle Weight Rating, Gross Combined Weight Rating, Axle Weight Ratings, maximum payload weight, curb weight, wheel base size, maximum passenger weight, maximum tongue load weight, towing capacity, rear axle weight, and front axle weight.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a side view of an exemplary vehicle connected with an exemplary trailer;

FIG. 3 is a flow chart of an exemplary method of attaining subjective vehicle capability information; and

FIG. 4 is an exemplary representation of exemplary specific capability determinations for subjective vehicle dynamics.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the exemplary aspects of the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

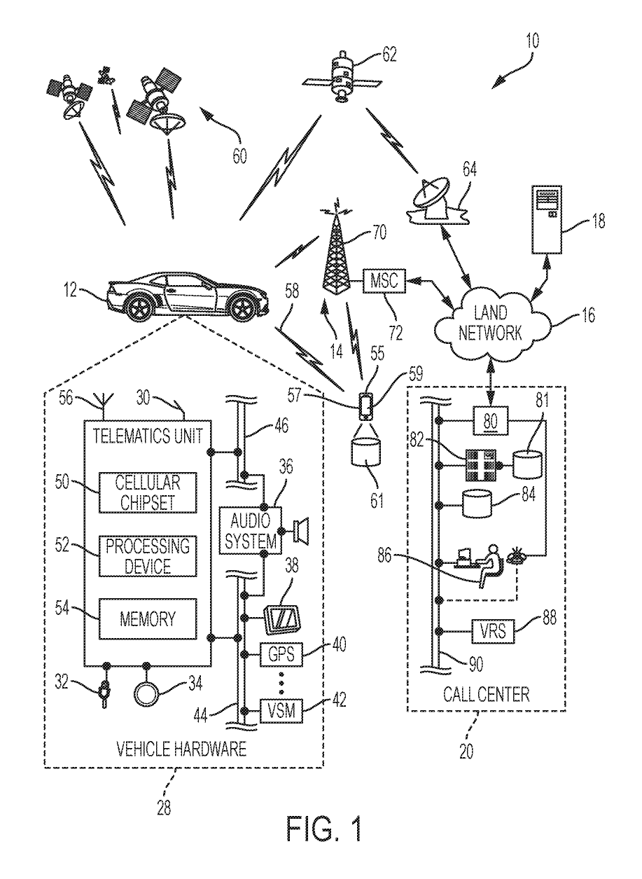

With reference to FIG. 1, there is shown an operating environment that includes, among other features, a mobile vehicle communications system 10 and that can be used to implement the method disclosed herein. Communications system 10 generally includes a vehicle 12, one or more wireless carrier systems 14, a land communications network 16, a computer 18, and a data center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with data center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the data center 20) and data communication (e.g., to provide GPS location data or vehicle diagnostic data to the data center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

One of the networked devices that can communicate with the telematics unit 30 is a mobile computing device 57, such as a smart phone. The mobile computing device 57 can include computer processing capability, a transceiver capable of communicating with wireless carrier system 14, a digital camera 55, a visual display 59, and/or a GPS module capable of receiving GPS satellite signals and generating GPS coordinates based on those signals. In some implementations, the display 59 also includes a touch-screen graphical user interface. Digital camera 55 may include the ability to generate digital images that are bitmapped data representations of tangible objects captured and stored by the operations of camera 55. Examples of the mobile computing device 57 include the iPhone™ manufactured by Apple, Inc. and the Droid™ manufactured by Motorola, Inc. as well as others. While the mobile computing device 57 may include the ability to communicate via cellular communications using the wireless carrier system 14, this is not always the case. For instance, Apple manufactures devices such as the various models of the iPad™ and iPod Touch™ that include the processing capability, the display 59, and the ability to communicate over a short-range wireless communication link. However, the iPod Touch™ and some iPads™ do not have cellular communication capabilities. Even so, these and other similar devices may be used or considered a type of wireless device, such as the mobile computing device 57, for the purposes of the method described herein.

Telematics Controller 52 (processor) can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Telematics Controller 52 executes various types of digitally-stored instructions, such as software or firmware programs stored in memory 54, which enable the telematics unit to provide a wide variety of services. For instance, controller 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to data center 20 or other remote computer system, such as computer 18, for other purposes, such as fleet management. Also, new or updated map data can be downloaded to the GPS module 40 from the data center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. VSM 42 can also be a vehicle load module equipped with on-board diagnostic (OBD) features that provide myriad real-time data such as, but not limited to, vehicle load weight, passenger weight, hitch vertical height, and weight being asserted on each vehicle axle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the data center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions (i.e., capable of GUI implementation). Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000 or 1×EV-DO) or GSM/GPRS (e.g., 4G LTE). As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to data center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, data center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or data center 20, or both. A computer 18 can also be used for providing Internet connectivity such as DNS services or as a network address server that uses DHCP or other suitable protocol to assign an IP address to the vehicle 12.

Data center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various data center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. Server 82 can incorporate a data controller 81 which essentially controls the overall operation and function of server 82. Controller 81 may control, send, and/or receive data information (e.g., data transmissions) from one or more of the data bases 84 and mobile computing device 57. Controller 81 is capable of reading executable instructions stored in a non-transitory machine readable medium and may include one or more from among a processor, a microprocessor, a central processing unit (CPU), a graphics processor, Application Specific Integrated Circuits (ASICs), Field-Programmable Gate Arrays (FPGAs), state machines, and a combination of hardware, software and firmware components. The live advisor phone can also use VoIP as indicated by the broken line in FIG. 1. VoIP and other data communication through the switch 80 is implemented via a modem (not shown) connected between the switch 80 and network 90.

Data transmissions are passed via the modem to server 82 and/or database 84. Database 84 can store account information such as, but not limited to, vehicle dynamics information, one or more vehicle dynamics modules (VDM), and other pertinent subscriber information. The vehicle dynamics information may include tables populated with vehicle base model capabilities. Such capabilities are those known in the art by skilled artisans and may include parameters such as, but not limited to, Gross Vehicle Weight Rating, Gross Combined Weight Rating (including hypothetical trailer weights for one or more base trailer models), Axle Weight Ratings (i.e., FGAWR and/or RGAWR), maximum payload weight, curb weight, wheel base size, maximum passenger weight, maximum tongue load weight, towing capacity, rear axle weight, front axle weight. Data transmissions may also be conducted by wireless systems, such as 802.11x, GPRS, and the like. Although the illustrated embodiment has been described as it would be used in conjunction with a manned data center 20 using live advisor 86, it will be appreciated that the data center can instead utilize VRS 88 as an automated advisor or, a combination of VRS 88 and the live advisor 86 can be used.

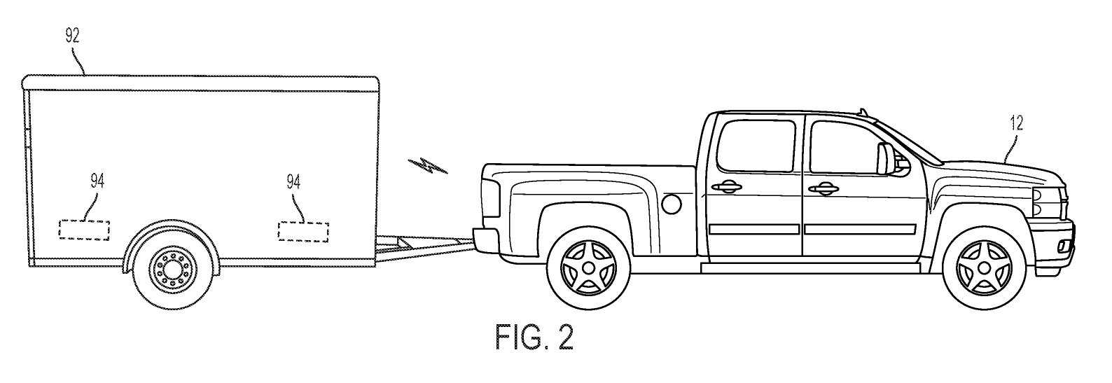

FIG. 2 shows an exemplary vehicle 12 being hitched to a trailer 92 which can include trailer system modules (TSMs) 94 in the form of electronic hardware components that are located throughout trailer 92 and typically receive input from one or more sensors and use the sensed input to perform diagnostic, monitoring, control, reporting and/or other functions. According to one embodiment, TSM 92 can be a trailer load module equipped with OBD features that provide myriad real-time trailer dynamics information data such as, but not limited to, trailer load weight, cargo configuration, and the weight being asserted on each trailer axle. TSM 94 may communicate data such as, but not limited to, the trailer dynamics information to telematics unit 30 over wireless carrier system 14 and/or via wireless networking according to one or more wireless protocols, discussed above, such as any of the IEEE 802.11 protocols, WiMAX, or Bluetooth. According to another embodiment, TSM 94 may communicate data to mobile computing device 57 over wireless carrier system 14 and/or via wireless networking according to one or more wireless protocols.

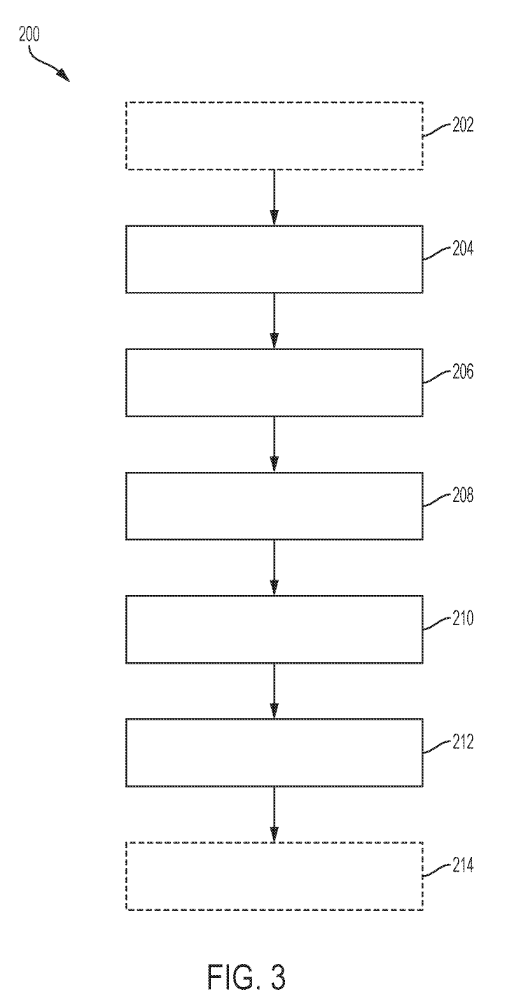

Turning now to FIG. 3, there is shown an example of method 200 of attaining subjective vehicle dynamics information. One or more steps of method 200 may be completed through the implementation of the VDM that may comprise one or more executable instructions (software algorithms) incorporated into database 80 and executed by controller 81 of server 82. Other aspects of VDM may moreover be incorporated into mobile computing device 57 and executed by a mobile processing device (equivalent to controller 81) incorporated therein.

The method 200 may optionally start by having a user provide a vehicle identity to mobile computing device 57. In one example, the aspect of VDM installed on mobile computing device 57 provides an interactive GUI on display 59, in which the user has the ability to upload the vehicle identity onto the mobile computing device 57. The vehicle identity may then be stored in one or more databases 61 (i.e., memory storage devices) of the mobile computing device 57. Beyond logos and textual information, the GUI may provide one or more prompts and command options that allow the user to physically deliver the vehicle identity information into the interactive GUI of VDM. Alternatively, inclusively, VDM may be configured to communicate with digital camera 55. In this example, a user would capture a digital image of the vehicle identity through the implementation of camera 55. The digital image would then be stored in the databases of mobile computing device or sent directly to the VDM. Through one or more user commands, VDM would then retrieve the digital image from the database or simply analyze information from the digital image to arrive at the proper vehicle identity information. It should be appreciated that the vehicle identity may include the Vehicle Identification Number (VIN) corresponding with the vehicle 12. It should be further appreciated that the digital image may capture an image of at least a portion of the interior dashboard, front of engine block (under the vehicle hood), or door jamb (e.g. through a label) to adequately acquire the VIN.

At optional step 202, the aspect of VDM incorporated into mobile computing device 57 would then generate data that includes the vehicle identity. The VDM would then access the transceiver in mobile computing device 57 to transmit at least one data transmission that includes information corresponding to the vehicle identity.

At step 204, the data transmission is received at server 82 of data center 20. Controller 81 then collaborates with the aspect of the VDM incorporated into data base 84 to recognize that the data transmission includes the vehicle identity. In collaboration, at step 206, controller 81 and VDM then access, from data base 84, at least the part of the tables of vehicle capabilities information that correspond to a base model of the vehicle model identified in the vehicle identity information. As discussed above, the table may be populated with information regarding Gross Vehicle Weight Ratings, Gross Combined Weight Ratings, Axle Weight Ratings, maximum payload weights, curb weights, wheel base sizes, maximum passenger weights, maximum tongue load weights, towing capacities, rear axle weights, front axle weights, and other relevant vehicle capabilities.

At step 208, controller 81, collaborating with VDM, reviews the vehicle capabilities information in relation to the vehicle identity. In this step, controller will pull the vehicle capabilities information for the specific vehicle model corresponding to the model reflected in the vehicle identification number. In some embodiments, one or more VSMs may provide vehicle dynamics information, discussed above, to the VDM at mobile computing device 57. This vehicle dynamics information is then tied into the vehicle identity information to provide a more realistic picture of vehicle 12 at the time information is uploaded to VDM. VDM may moreover automatically prompt the VSMs (i.e., directly or indirectly via the vehicle telematics unit 30) upon being provided other portions of the vehicle identity information, discussed above. In other embodiments, one or more TSMs (FIG. 3) may provide trailer dynamics information, discussed above, to the VDM at mobile computing device 57. This vehicle dynamics information is then tied into the vehicle identity information to provide a more realistic picture of vehicle 12 at the time information is uploaded to VDM. VDM may moreover automatically prompt the TSMs (i.e., directly or indirectly via the vehicle telematics unit 30) upon being provided other portions of the vehicle identity information.

At step 210, VDM and controller 81 will calculate and generate the subjective vehicle dynamics information. These subjective vehicle dynamics may simply be a copied part of the tables of vehicle capabilities information that relates to the vehicle model reflected in the vehicle identity information. However, in embodiments where additional information is incorporated into the vehicle identity information (e.g., via the VSMs and/or TSMs), the subjective vehicle dynamics information may include a specific capabilities determination for the vehicle, discussed below.

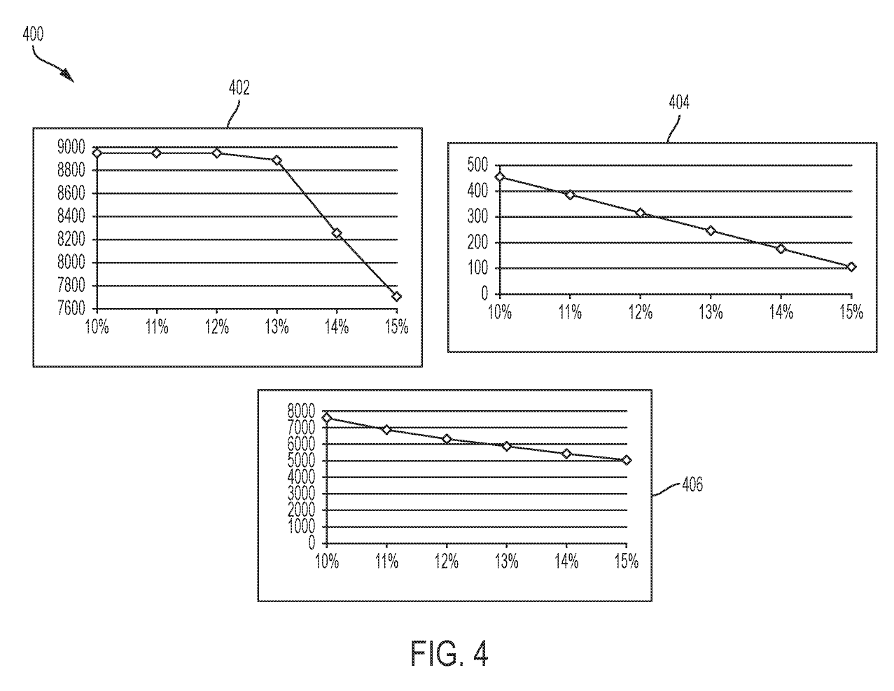

At step 212, the controller will cause server 82 to transmit data which includes the subjective vehicle dynamics information over wireless carrier network 14 (or land network 16). At optional step 214, the data transmissions are received at the mobile computing device 57. With additional reference to FIG. 4, VDM and controller 81 may make one or more computations to create a capabilities determination exemplified as one or more GUI charts 400 and may be viewed on display 59. Exemplary charts 400 may moreover represent information such as, but not limited to, the amount maximum allowed trailer weight by tongue weight percentage 402 (generated as the max trailer weight by tongue weight percentage), the maximum allowed weight which can be added to the current trailer payload 404 (generated as cargo weight by tongue weight percentage), and/or the maximum trailer size and/or weight which may safely be carried by vehicle 406 (generated as the max trailer weight by tongue weight percentage). It should be appreciated that the disclosed data outputs shown in each chart may be understood as the sensitivities to tongue weight.

In other embodiments, VDM and controller 81 may make one or more computations to create a capabilities determination that are substantially binary in their nature. As such, VDM and controller 81 may provide a “Go/No-Go” output that may be viewed on display 59. This “Go/No-Go” output may be displayed as text (e.g., stating “Trailer Safely Loaded” or “Trailer Overloaded”) or may be displayed in an aesthetic manner (e.g., colors such as “Green and Red” block colors or “X and O” symbols).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of attaining subjective vehicle dynamics information, the method comprising:
(a) receiving, at a controller, one or more data transmissions comprising a vehicle identity;
(b) accessing, via the controller, one or more data bases comprising vehicle capabilities information;
(c) reviewing, via the controller, the vehicle capabilities information in relation to the vehicle identity;
(d) generating, via the controller, subjective vehicle dynamics information based upon the review of the vehicle dynamics information in relation to the vehicle identity; and
(e) transmitting one or more data transmissions comprising at least a portion of the subjective vehicle dynamics information.

2. The method of claim 1, further comprising transmitting, via a mobile computing device, the one or more data transmissions comprising the vehicle identity to the controller.

3. The method of claim 2, wherein the vehicle identity is acquired by the mobile computing device via a digital image captured by a camera.

4. The method of claim 1, further comprising receiving, at a mobile computing device, one or more data transmissions from the controller, the one or more data transmissions comprising the subjective vehicle dynamics information.

5. The method of claim 1, wherein the controller is located at a data center server.

6. The method of claim 1, wherein the vehicle identity comprises vehicle dynamics information provided via one or more vehicle system modules.

7. The method of claim 1, wherein the vehicle identity comprises trailer dynamics information provided via one or more trailer system modules.

8. The method of claim 1, wherein the subjective vehicle dynamics information comprises a capabilities determination.

9. The method of claim 1, wherein the vehicle capabilities information comprises a table populated with information regarding at least one of a Gross Vehicle Weight Rating, Gross Combined Weight Rating, Axle Weight Ratings, maximum payload weight, curb weight, wheel base size, maximum passenger weight, maximum tongue load weight, towing capacity, rear axle weight, and front axle weight.

10. A method of attaining subjective vehicle dynamics information, comprising the steps of:
(a) transmitting, via a mobile computing device, one or more data transmissions comprising the vehicle identity;
(b) receiving, at a data center server, one or more data transmissions comprising a vehicle identity;
(b) accessing, via the data center server, one or more data bases comprising vehicle capabilities information;
(c) reviewing, via the data center server, the vehicle capabilities information in relation to the vehicle identity;
(d) generating, via the data center server, the subjective vehicle dynamics information comprising a capabilities determination based upon the review of the vehicle dynamics information in relation to the vehicle identity; and
(e) transmitting, via a network, one or more data transmissions comprising at least a portion of the subjective vehicle dynamics information; and
(f) receiving, at a mobile computing device, one or more data transmissions comprising the subjective vehicle dynamics information.

11. The method of claim 10, wherein the vehicle identity is acquired by the mobile computing device via a digital image captured by a camera.

12. The method of claim 10, wherein the vehicle identity comprises vehicle dynamics information provided via one or more vehicle system modules.

13. The method of claim 10, wherein the vehicle identity comprises trailer dynamics information provided via one or more trailer system modules.

14. The method of claim 1, wherein the vehicle capabilities information comprises a table populated with information regarding at least one of a Gross Vehicle Weight Rating, Gross Combined Weight Rating, Axle Weight Ratings, maximum payload weight, curb weight, wheel base size, maximum passenger weight, maximum tongue load weight, towing capacity, rear axle weight, and front axle weight.

15. A non-transitory machine readable medium having stored thereon executable instructions to attain subjective vehicle dynamics information, comprising machine executable code which when provided a vehicle identity and executed by at least one machine, causes the machine to:
(a) access one or more data bases comprising vehicle capabilities information;
(b) review the vehicle capabilities information in relation to the vehicle identity;
(c) generate the subjective vehicle dynamics information that comprises a capabilities determination based upon the review of the vehicle dynamics information in relation to the vehicle identity; and
(d) transmit at least a portion of the subjective vehicle dynamics information through a network.

16. The non-transitory machine readable medium of claim 15, wherein the vehicle identity is provided by a mobile computing device.

17. The non-transitory machine readable medium of claim 15, wherein the vehicle identity is provided by a mobile computing device upon processing a digital image captured by a camera.

18. The non-transitory machine readable medium of claim 15, wherein the vehicle identity comprises vehicle dynamics information provided by one or more vehicle system modules.

19. The non-transitory machine readable medium of claim 15, wherein the vehicle identity comprises trailer dynamics information provided by one or more trailer system modules.

20. The non-transitory machine readable medium of claim 15, wherein the vehicle capabilities information comprises a table populated with information regarding at least one of a Gross Vehicle Weight Rating, Gross Combined Weight Rating, Axle Weight Ratings, maximum payload weight, curb weight, wheel base size, maximum passenger weight, maximum tongue load weight, towing capacity, rear axle weight, and front axle weight.
